(19) United States
(12) Patent Application Publication
(10) Pub. No.: US 2012/0064924 A1
(43) Pub. Date: Mar. 15, 2012

(54) Reducing driver distraction due to mobile text messaging

(75) Inventors: Claudio Schapsis, Plantation, FL (US); Eitan Schapsis, Plantation, FL (US)

(73) Assignee: Alter App. LLC, Plantation, FL (US)

(21) Appl. No.: 12/879,765

(22) Filed: Sep. 10, 2010

(51) Int. Cl. H04W 4/12

(52) U.S. Cl. 455/466

(57) ABSTRACT

A method for auto-responding to text messages includes: activating an automatic response message feature on a first communication device; receiving input including a response message that includes an amount of time and an increment of time from a user of the device; receiving a communication from a second communication device; determining if the response message should be transmitted; and transmitting the response message including the remaining time. Additionally, a branding option can be used to monetize the process.

### FIELD OF THE INVENTION

The present invention relates to wireless communication systems. More particularly, the present invention relates to a novel and improved system and method to reduce driver distraction due to mobile text messaging.

### BACKGROUND OF THE INVENTION

Today's proliferation of mobile communication devices offers reliable real-time communication with instant response, allowing individuals to be connected and available at all times. SMS (Short Message Service), also known as the ubiquitous “text message” is currently the most widely used data application in the world. This convenience, however, has become an intrusion into what traditionally had been an individual's “down” time, such as while driving. Distracted driving accounts for approximately twenty-five percent of all police-reported traffic accidents and sadly many of those accidents result in death and/or serious injury. Driving while Distracted (DWD) refers to the growing trend of driving a motor vehicle while talking or texting on a mobile phone. With more than four billion mobile cellular subscribers worldwide, the risk is growing exponentially.

Some solutions have been proposed to address this growing problem. For example, United States Patent Publication No. 2005/0170869A1 “Car-Safe Messaging interfaces for interactive pagers and related methods” offers a solution to the problem by allowing a driver to quickly answer a message by selecting from predefined messages. The shortcoming to this invention is that the driver is still required to interact with the phone in order to see who is calling and select the pre-defined response. The driver must deviate his/her attention from the road in order to make the selection.

Therefore, there is a need for a method to address the problem of driver distraction.

### SUMMARY OF THE INVENTION

Briefly, according to an embodiment of the invention a method includes steps or acts of: receiving as input an automatic response message that includes a time limit from a user of the first communication device; activating an automatic response message feature for automatically generating and transmitting the automatic response message in real-time without user interaction; accessing a clock timer; and determining remaining time by decrementing the clock timer by a time increment until zero is reached, beginning with the time limit. Once a communication from a second communication device is received, the method continues by: determining if the automatic response message should be transmitted to the second communication device; when it is determined that the automatic response message should be transmitted to the second communication device: embedding a value of the remaining time to the automatic response message to generate a timed response; and transmitting the timed response message to the second communication device.

According to another embodiment of the invention, a method includes steps or acts of: receiving as input an automatic response message from a user of a first communication device; activating an automatic response message feature for automatically preparing and transmitting a response comprising the automatic response message without user interaction; receiving a communication from a second communication device; and determining if the automatic response message should be transmitted to the second communication device. When it is determined that the automatic response message should be transmitted, the method proceeds by: retrieving a branding message; inserting the branding message into the automatic response message to produce a branded response message; and transmitting the branded response message to the second communication device.

The method can also be implemented as machine executable instructions executed by a programmable information processing system or as hard coded logic in a specialized computing apparatus such as an application-specific integrated circuit (ASIC).

### BRIEF DESCRIPTION OF THE SEVERAL VIEWS OF THE DRAWINGS

To describe the foregoing and other exemplary purposes, aspects, and advantages, we use the following detailed description of an exemplary embodiment of the invention with reference to the drawings, in which:

FIG. 1 is a flowchart of the auto-response method according to an embodiment of the present invention;

FIG. 2 is a flowchart of the auto-response method according to another embodiment of the present invention;

FIG. 3A is a flowchart of the auto-response method, according to another embodiment of the present invention;

FIG. 3B shows customized auto-responses selected in the pre-configuration process of FIG. 3A, according to an embodiment of the present invention;

FIG. 4A is a flowchart of the timer option, according to an embodiment of the present invention;

FIG. 4B shows a diagram of the data flow between two phones, according to an embodiment of the present invention;

FIG. 4C shows a diagram of the data flow between two phones with the Twitter option, according to an embodiment of the present invention;

FIG. 5 shows the pre-configuration process used with the process described in the flowchart of FIG. 4A, according to an embodiment of the present invention;

FIG. 6A is a flowchart of the branding embodiment, according to an embodiment of the present invention;

FIG. 6B shows the device interaction when the branding functionality is implemented, according to an embodiment of the present invention;

FIG. 7 shows the remote device implementation, according to an embodiment of the present invention;

FIG. 8 is a high level block diagram showing an information processing system according to another embodiment of the invention;

FIG. 9 shows the process flow between two devices in a communication, according to an embodiment of the present invention;

FIGS. 10A through 10D show illustrations of an exemplary user interface, according to an embodiment of the present invention;

FIG. 11A shows the exemplary user interface of FIG. 10A in Custom mode, according to an embodiment of the present invention;

FIG. 11B shows the Auto mode implementation of the exemplary user interface of FIG. 10A in Auto Mode, according to an embodiment of the present invention;

FIG. 11C shows the exemplary user interface of FIG. 11B with the Auto Mode active, according to an embodiment of the present invention;

FIG. 12 is a flowchart of the auto-response method using the timer option, according to an embodiment of the present invention;

FIG. 13 is a sub-process of the flowchart of FIG. 12 showing the processing steps when the SENDER is not associated with a customized message;

FIG. 14 is a sub-process of the flowchart of FIG. 12 showing the processing steps when the SENDER is associated with a customized message; and

FIG. 15 shows an exemplary user interface for the Group feature, according to an embodiment of the present invention.

While the invention as claimed can be modified into alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents and alternatives falling within the scope of the present invention.

### DETAILED DESCRIPTION

We describe an automatic response system and method that allows targeted real-time communication between two devices without any user interaction. The automatic response system is configured to “answer” a call or text message by transmitting an auto-generated response message of the user's choosing. The automatic response system can be advantageously used with a cell phone, personal digital assistant (PDA), or other device configured to receive and transmit text messages.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. In the following description, numerous specific details are set forth by way of exemplary embodiments in order to provide a more thorough description of the present invention. However, to clarify the key features of the invention, the various embodiments are described throughout this document using mobile to mobile text messaging because of its familiarity. It will be well understood to those with knowledge in the art that other forms of communication, such as Instant Messaging (IM), Multimedia Messaging (MMS), Enhanced Multimedia Messaging (EMS), and other communication protocols that are known or in development can be advantageously used within the spirit and scope of the invention.

A user will activate the auto-response application whenever the user wants to avoid the distraction of answering a text message; but yet does not wish to ignore the text message, such as when the user is preparing to engage in a non-distractible activity. Basically, any activity from which the user does not wish to be distracted will be referred to as a non-distractible activity. Typical non-distractible activities are: driving, attending a meeting, working, watching a movie, and attending a social function. The application remains in AUTO mode until the application is terminated by the user. In AUTO mode the application will automatically generate and transmit appropriate automatic response messages without user interaction. The application can be terminated by the user explicitly terminating the application or by the user turning off the mobile device. Until terminated, however, the application remains in AUTO mode processing all incoming messages. Note that processing the incoming messages can include ignoring designated SENDERS.

The auto-response application allows the user to define an automatic reply message to be used by the application while it is in AUTO mode. The auto-response message is any message that the user selects as a response to an incoming message. Some examples of auto-response messages are: “I'm driving right now—will call u back;” and “In a meeting—will respond later.”

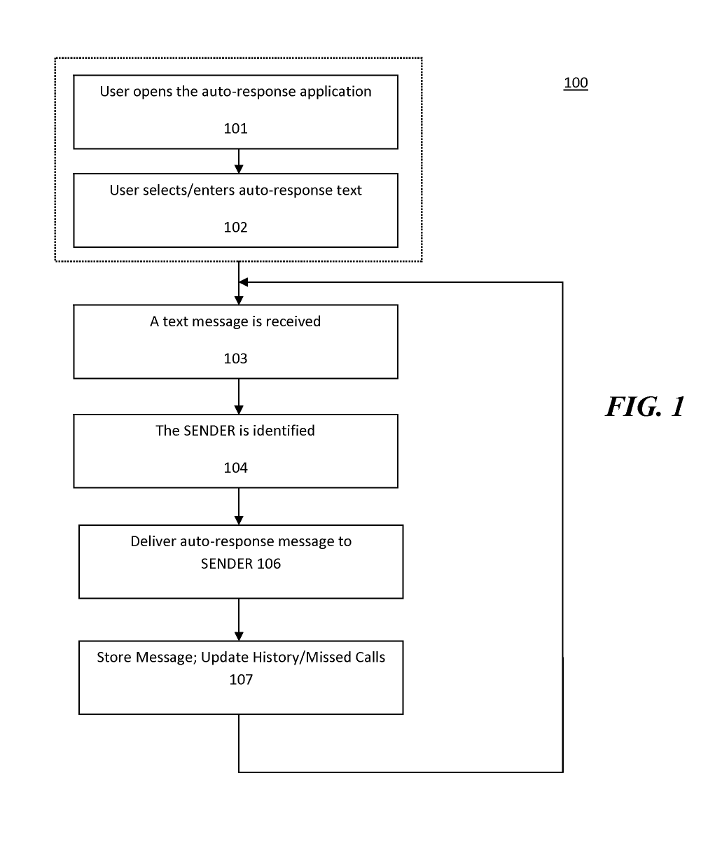

Referring to FIG. 1, there is shown a flowchart 100 of the auto-response method according to an embodiment of the present invention. The method begins at step 101 when the user opens the auto-response application on the user's phone or other device and activates the application by setting the application in AUTO mode. While the application is active, an incoming communication, such as a text message under the Short Message Service (SMS) protocol, can be automatically answered with a pre-configured auto-response message which the user enters in step 102. The application remains active and monitoring the activity of the phone. When a text message arrives in step 103, concurrent with the arrival of the text message, the SENDER is identified on the user's phone at step 104, by known methods such as Caller ID which is a standard function on modern mobile phones.

In step 106, responsive to receiving the text message, an auto-response message is delivered to the SENDER, if appropriate. The body of the auto-response message is the pre-configured message selected (accepted) by the user. Step 107 stores the incoming message, and updates the history and/or missed calls. The application stays in AUTO mode until terminated by the user.

The assumptions to the process are that the auto-response application is available on the user's device and that the device includes a user interface such as a touch screen, or a display and keypad combination. The application can be downloaded, or it can be delivered (bundled) as part of the phone functions included when purchasing the device. Preferably, the user activates the auto-response application prior to engaging in any activity during which the user is not available (or does not wish) to take calls and/or text messages. Once the auto-response application is activated, the user can either select an available auto-response message or input a new auto-response message.

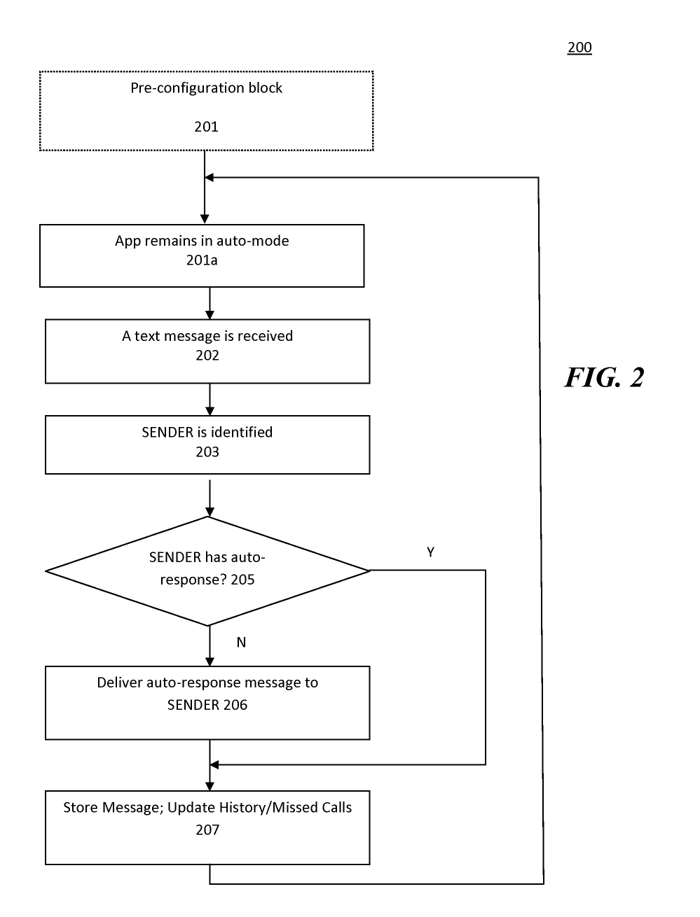

Preferably, the auto-response application will recognize if the incoming message originates from a SENDER phone running the same auto-response application. If that is the case, the auto-response application will NOT generate and send an auto-response message. The reason for this is to avoid an infinite loop of two phones sending auto-response messages to each other. The flowchart 200 of FIG. 2 shows this process. Step 201 is the pre-configuration block that encompasses steps 101 and 102 of FIG. 1. In step 201a the application remains in AUTO mode. In step 202 a text message is received and in step 203 the SENDER is identified.

In step 205 a determination is made as to whether or not the SENDER also has auto-response activated. One method to determine if the SENDER has this feature activated is by providing a particular set of characters that will be included in the auto-response. For example, assume SENDERS A and B have both activated the application on their phones. A sends a regular SMS text message to B. B receives the text message and generates an auto response adding a particular set of characters identifying this as an auto-response, for example “#Automsg dnttxtndrv#.” If B pre-configured the auto answer as “driving right now—will call u back” then A will receive a text message saying “driving right now—will call u back #Automsg dnttxtndrv#.”

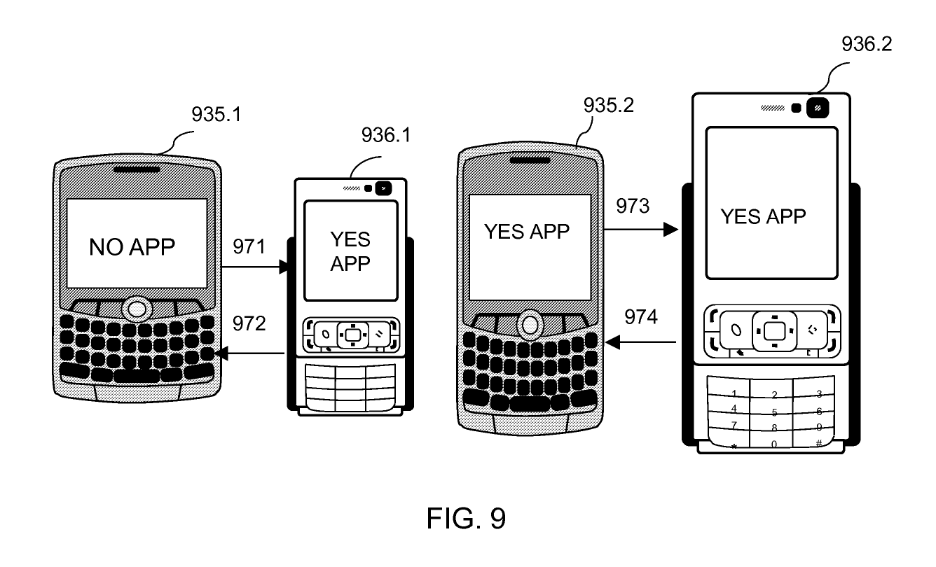

When A receives the message the application in A's phone will recognize the string “#Automsg dnttxtndrv#” as identifying the auto-response feature and will not generate an additional text message in responding to B. In the example shown in FIG. 9, phone 935.1 has no auto-response feature activated; and phone 936.1 has the auto-response application activated. When phone 935.1 sends any text message 971 to phone 936.1, phone 936.1 will answer with the preconfigured and processed message. i.e. “driving right now—will call u back #Automsg dnttxtndrv#” 972. The string ‘#Automsg dnttxtndrv#” was added by phone 936.1 before sending the pre-configured auto response.

In the second case phone 935.2 and phone 936.2 both have the auto-response application working. When phone 935.2 sends a regular text message 973 to phone 936.2, phone 936.2 will answer with the preconfigured and processed message. i.e. “driving right now—will call u back “#Automsg dnttxtndrv#” 974. The string “#Automsg dnttxtndrv#” was added by phone 936.2 before sending the preconfigured auto response. This message will be processed by the application at phone 935.2 as any other entering text message.

While recognizing the text string “#Automsg dnttxtndrv#” as part of the message 974 phone 935.2 will not generate an additional message. Note: the string “#Automsg dnttxtndrv#” is an example and when implemented, can be this character string or a group of different sets of strings that will indicate not to generate an answer; or for example, a text answering a certain format i.e. “̂xxxxxx̂” (a set of any six alpha numeric characters heading and tailing those characters). This illustration is exemplary; the developer will define the general rule for recognizing the auto response message.

Returning to the flowchart of FIG. 2, if the SENDER has auto-response activated, then the process skips to step 207 where general housekeeping functions are performed, such as storing the incoming message, and updating the history and/or missed call logs. If the SENDER does not have auto-response activated, then in step 206 the auto-response message is delivered to the SENDER. This mechanism is conceived to avoid the loop between phones but not necessarily to avoid answering a phone with the auto-response application installed.

The application recognizes text messages generated as auto response messages rather than phones that have the application functioning. The auto-response application will respond to a text message coming from a phone that has the application functioning if that text message was NOT generated by the application, but by the user. Additional methods can be used to avoid an infinite loop, such as limiting the number of messages returned to a same SENDER in a period of time.

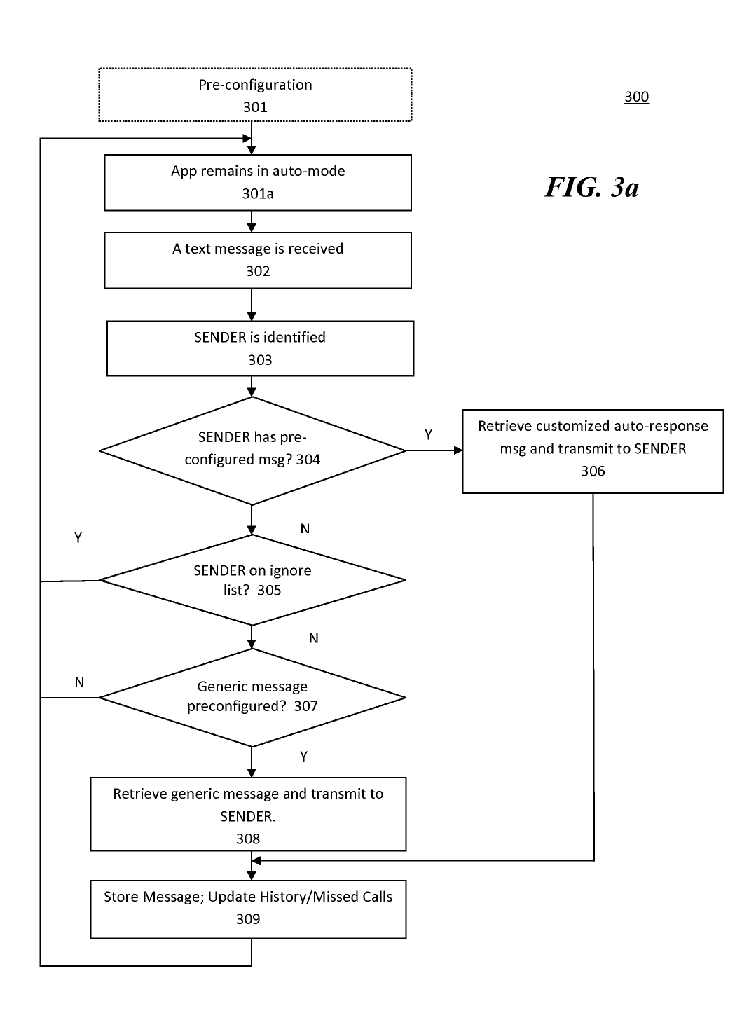

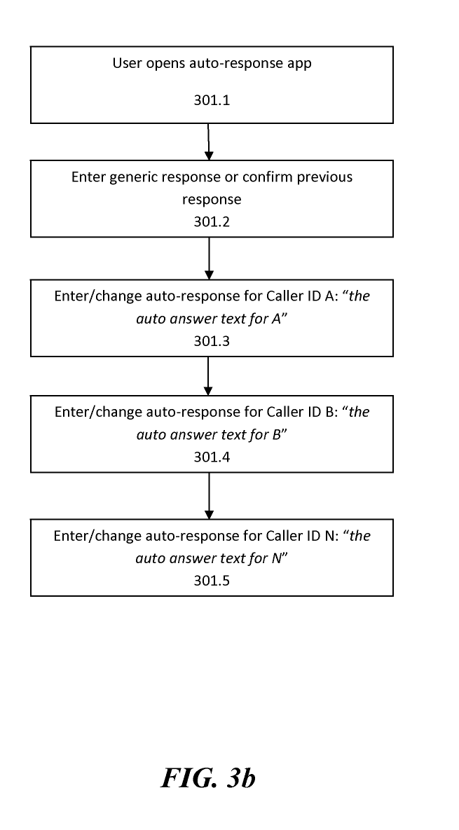

Referring now to FIG. 3a, there is shown a flowchart 300 of the auto-response method using a customizable option. In step 301, in the pre-configuration block the user is able to configure customized auto-response messages. The configuration is previously done in order to place the auto-response application in listening mode and is not done automatically. Note that in this case the message that is configured can be selected from among a group of pre-generated messages or it can be a customized message entered in a text field. This will afford the user the greatest flexibility in customizing responses to selected SENDERS and ignore any other incoming messages. The application remains in AUTO mode (listening mode) in step 301a.

During the time period in which the auto-response application is in the active state, any incoming text message received at step 302 will be automatically answered according to which SENDER sent the message. The SENDER is identified in step 303. Once the SENDER is identified, the application will select the auto-response message that “matches” the SENDER. If the SENDER is associated with a customized message as determined in step 304, that customized message will be returned in step 306.

If the user wishes to answer only certain SENDERS and ignore other SENDERS, the user simply selects those SENDERS to answer and then the user must de-select the general message option. The general message can be a message that is available with the auto-response application, or it can be a message selected by the user. In a preferred embodiment of the present invention, the auto-response application will be installed with a standard general message available for use.

In this custom-select state, the application auto-responds only to the selected SENDERS. Any other SENDERS will be ignored, which means that the device will process the ignored SENDER'S message as any other incoming message. In step 304 a determination is made as to whether the SENDER identified in step 303 is associated with a customized auto-response message. If this is the case, then in step 306 the customized auto-response message for that SENDER is retrieved and the message is delivered to the SENDER. However, if the SENDER from step 304 is not associated with any customized auto-response messages, then in step 305 a check is performed to determine if the SENDER is on the Ignore list. If so, the process loops back to step 301A and remains in AUTO mode until terminated.

If, however, the SENDER is not on the Ignore list, then in step 307 a check is performed to determine if a generic, or default auto-response message, is available. Leaving the general message field empty is one way to indicate that only selected SENDERS will be answered; all others will be ignored. If a generic, or default auto-response message, is available, then in step 308 the generic auto-response message is retrieved and delivered to the SENDER. Lastly, in step 309, the general housekeeping routines such as storing the message, updating message history and/or the missed calls log are performed.

Referring now to FIG. 3b, we show a diagram of the pre-configuration step 301 of FIG. 3A. The user opens the auto-response application in step 301.1. The user can optionally enter a generic response such as “I can't answer right now” in step 301.2. This generic response can be used as a default response to send to any SENDER not selected to receive a customized message. Alternately, the generic response can be used in conjunction with a customized message, for example, by either pre-pending or appending the generic response to a customized message.

The user is able to pre-configure numerous specific messages to specific SENDERS, with or without incorporating the generic response. In the diagram of FIG. 3B, we can see that the user can configure “the auto answer for A” in (301.3) as a response to be sent in response to a message from Caller ID A; “the auto answer for B” in (301.4) to be sent as a response to a message from Caller ID B; and “the auto answer for N” in (301.5) that will be sent as a response to a message from Caller ID N. The maximum number of pre-configured messages that can be stored will be dependent on the proprietary storage limitations of the individual device.

As an example, a person can set up a generic message such as “I can't answer right now,” then append a customized auto-response message for his wife's number such as “I'm driving to the beach” so that every incoming text coming from her will be answered “I can't answer right now—I'm driving to the beach.” This same user may want to customize an auto-response message to his manager to be answered with “In a meeting—I can't answer right now.” It should be noted that the customized auto-response message does not necessarily have to include the generic message. It can be any message within the maximum character limit for text messages, minus the identifier added by the application to signal this message as an auto-response. Currently the maximum character limit (max char) for a text message is 160 characters.

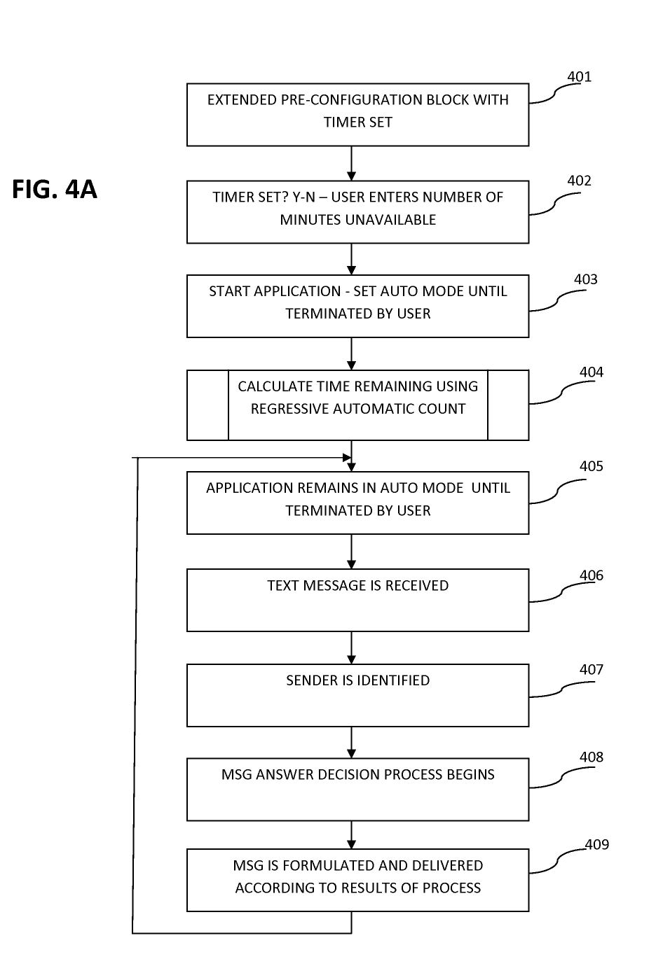

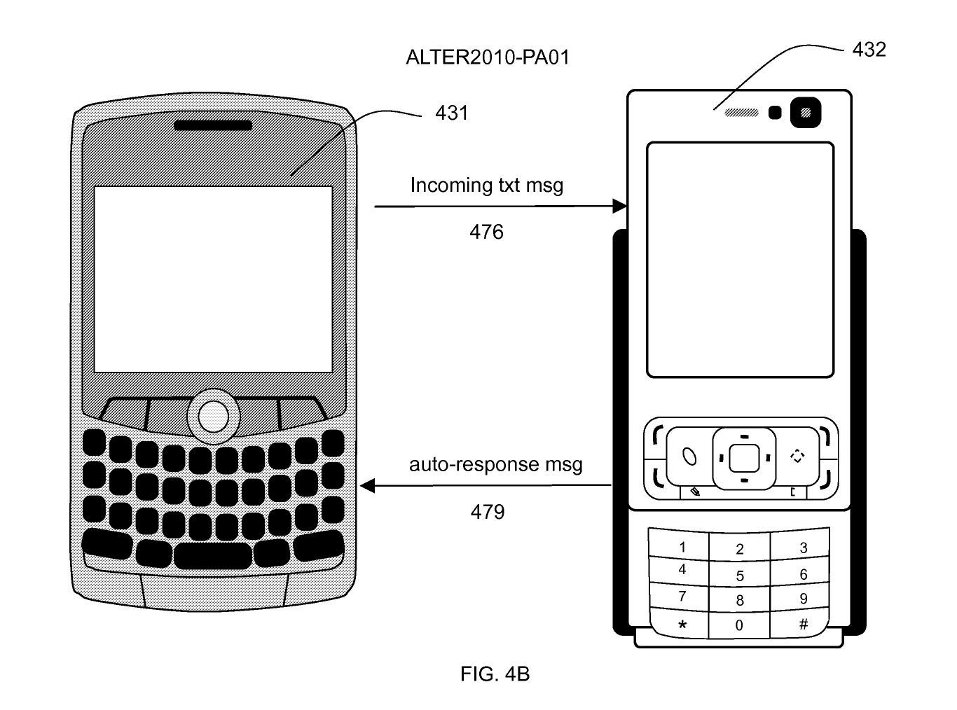

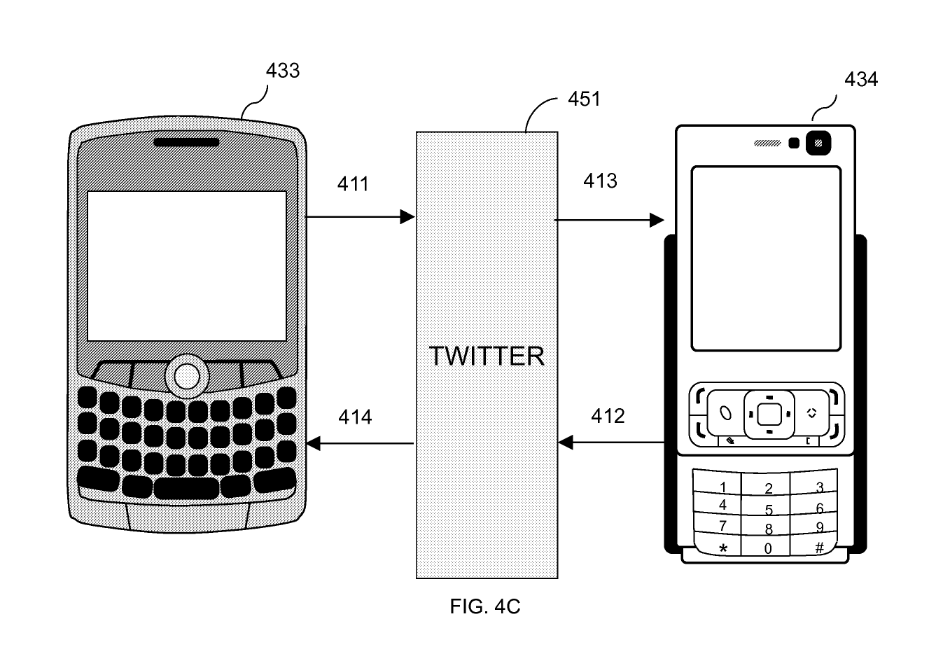

Referring now to FIGS. 4A and 4B we show a flowchart 400 and an example of data transmission using the auto-response application. When the user is ready to engage in a non-distractible activity, such as driving, he/she will open the application on his/her mobile device 432 and will be able to change or confirm the responses to text messaging SENDERS 431 as will be described in more detail below. If, as part of the pre-configuration 401, the user selected to have a timed auto-response, the application will allow the user to input the number of minutes he/she will be engaged in that activity in step 402. The user will put the application in AUTO mode in step 403.

When the user activates the application in AUTO mode 403 and if the timed option is selected 402, then the timer will start a regressive count. Then the application will begin to constantly ‘listen” for any incoming messages in step 405 until ended by the user. If a person with a device with text message capabilities (the “SENDER”) 431 sends a text message 476 to the device 432 and the text message 476 is received in step 406 by the device 432, the Caller ID of the SENDER 431 will be identified at step 407.

The application will process the Caller ID of the SENDER 431 and determine if a message should be returned and if so, what type of message should be returned to the SENDER 431. According to the results of the process 408 the application will send an auto-response text message 479 back to the SENDER 431 at step 409. The application will remain working and monitoring the activity of the device 432 until the next text message arrives or the user terminates the application.

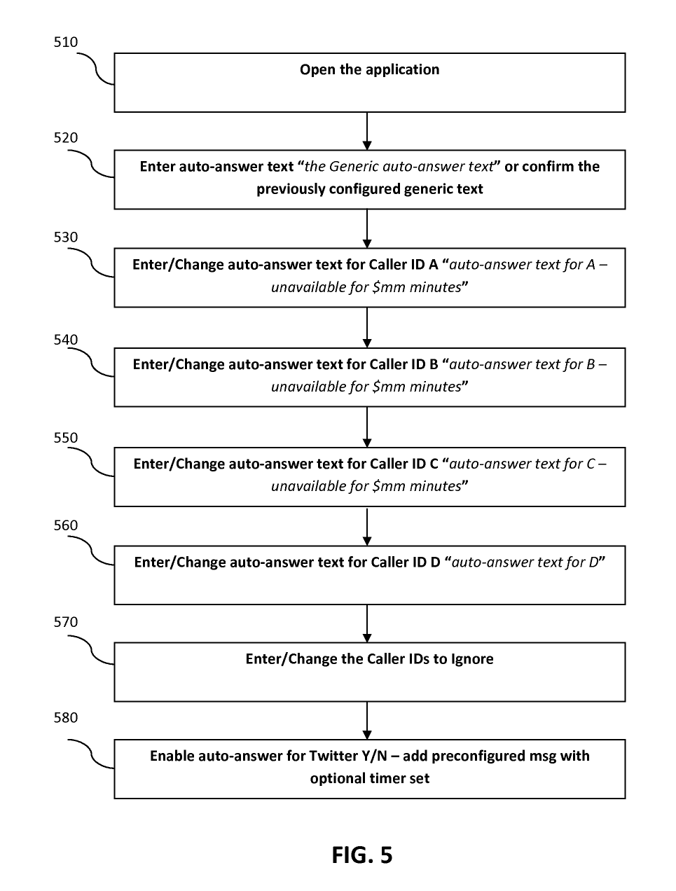

The pre-configuration step 401 is discussed now with respect to FIG. 5. The flow diagram of FIG. 5 shows a possible scenario for pre-configuring the auto-response application using the Timer option. The process begins when the user opens the auto-response application in step 510. Then, optionally, the user can enter text to be used for a generic (default) message or else accept a previously configured generic message in step 520. In steps 530, 540, and 550 the user enters or changes the message text used to reply to the SENDERS identified as Caller ID A, Caller ID B, and Caller ID C, respectively, using the Timer option.

Step 560 highlights the selectivity feature of the Timer option wherein the Timer option, once selected for a SENDER (or group of SENDERS), does not have to be used with all SENDERS. Here in step 560 the user configures a message for Caller ID D that does not include the Timer option. In step 570 the user is able to enter or change the Caller IDs on the Ignore list, while in step 580 the user is able to set the Twitter option. This is just one example of the interoperability and extended functionality of the multiple features available with the auto-response application.

SENDER Identification.

In addition to a telephone number, a SENDER can be identified by a short code. A short code is a mobile code with less than ten digits (usually five) that is associated with an individual, organization, media brand, or event. Additionally, a SENDER may be identified by a user ID associated with a SENDER'S social networking account, such as a Twitter account. For example FIG. 4C shows a user 433 with a twitter account associated with user ID “twitter433.” SENDER 433 sends a direct message 411 of “Hello, how are you?” to receiver 434, either through a mobile phone using SMS services, a web interface, or any other application interface that can communicate with twitter services 451. The receiver 434 has a twitter account with user ID “twitter434.” The receiver receives a text message from a shortcode i.e., “40404” 412 with a text such as “Direct from twitter433: Hello how are you?” In this case the caller ID for the text message is “40404” (the shortcode) but the ID of the SENDER is “twitter433.”

Therefore, if appropriate, the preconfigured auto-response that was set up in step 401 should be sent out to “twitter433” through twitter services 451. The application will process the message and send 413 a message to “twitter433” through the Twitter services 451. The SENDER 433 will receive a message 414 such as “Direct from twitter434: auto-response message.” The Twitter process is well known and is presented here as an example of how the application can be implemented to automate answering activities and reduce the interaction with the handset while driving and performing other activities.

Pre-Configuration Block.

For most of the embodiments, the application will have a pre-configuration block that includes some or all of the settings described below. It should be clear that the message examples provided here are for illustrative purposes only and to highlight the features of the invention; they are not comprehensive. Other optional settings can be advantageously employed within the spirit and scope of the invention, such as “ignore international numbers,” “ignore messages out of my area code,” “do not answer a Sender more than x times in a period of x minutes,” “don't answer messages sent by the same application,” or any other settings that may add to the extended functionality of the application. We define a pre-configuration block as the set of procedures that are performed when the auto-response application is opened.

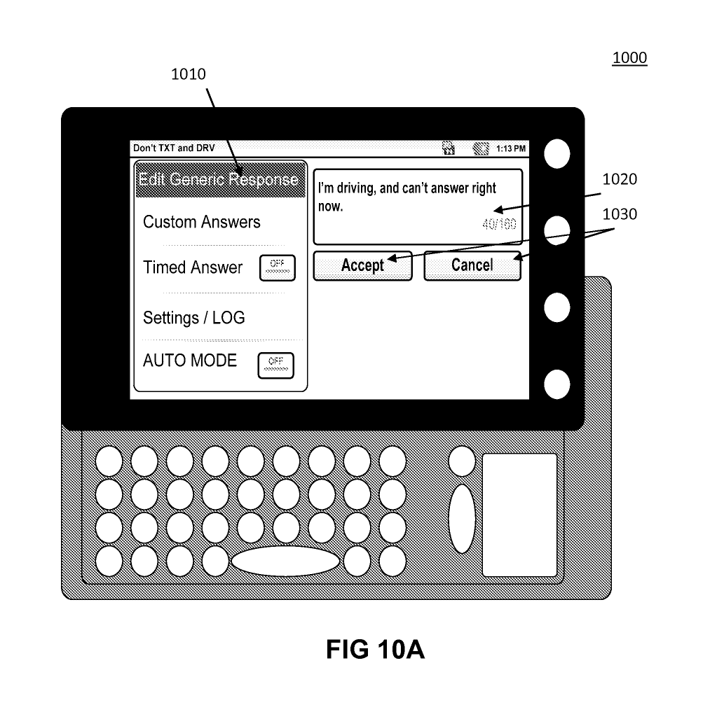

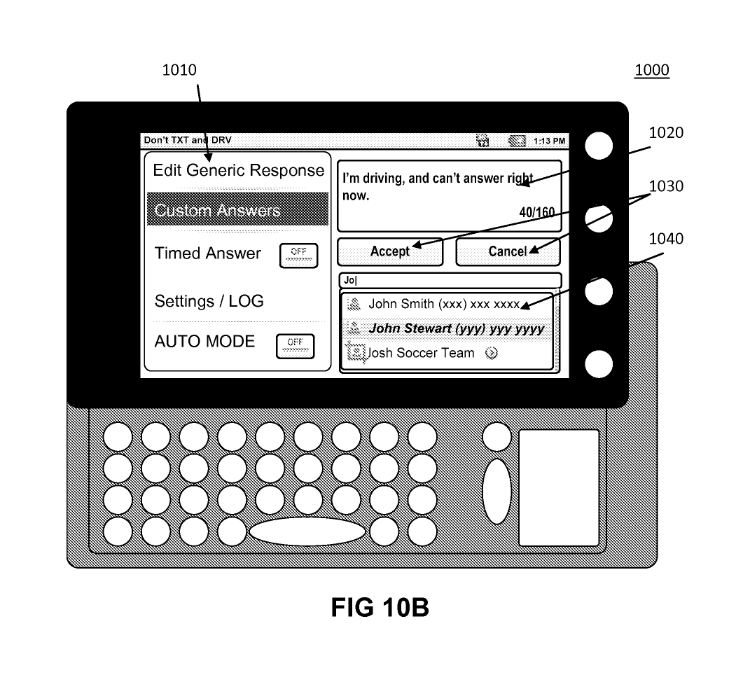

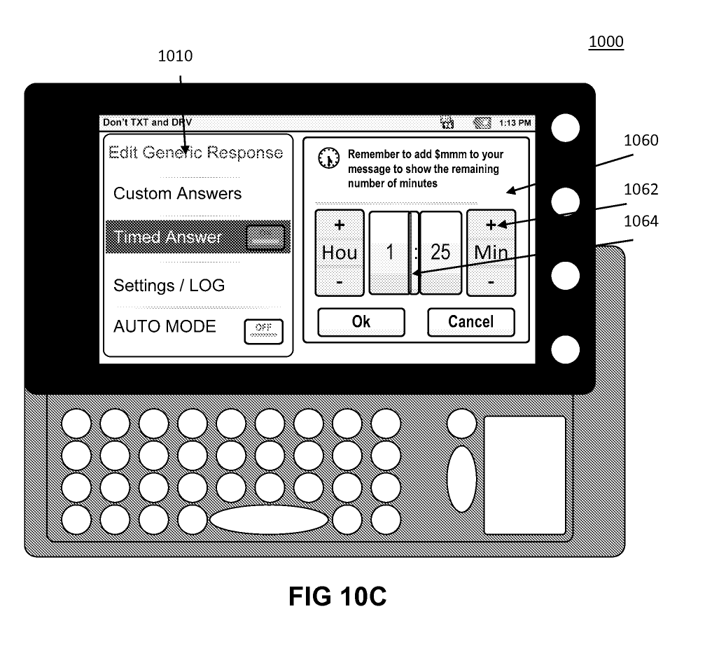

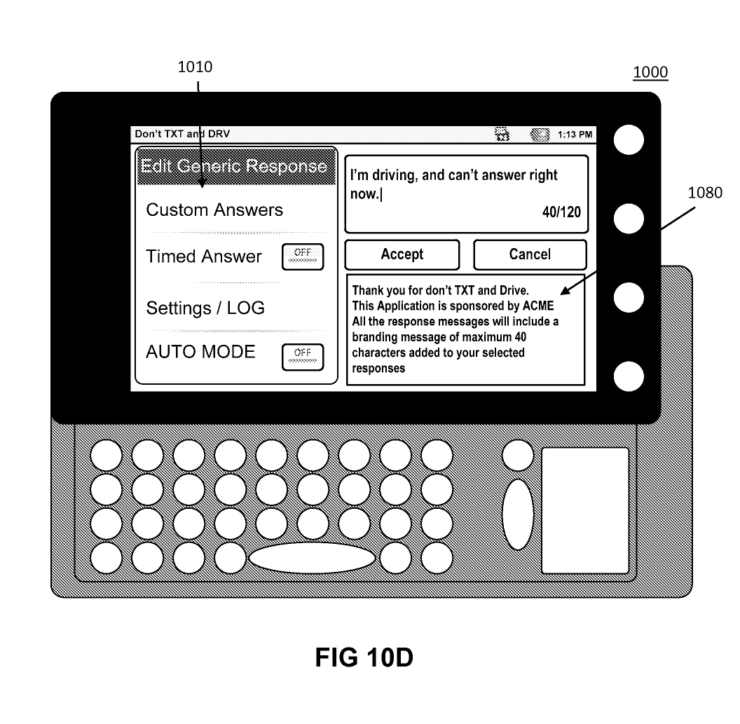

Referring to FIGS. 10A through 10D, we illustrate an exemplary user interface on a cell phone 1000 for pre-configuring auto-response message options. These illustrations are provided for clarification and should not be interpreted as limiting the invention to the interface shown or the configuration steps illustrated by these screens. FIG. 10A shows an exemplary cell phone 1000 with text messaging capability. The auto-response application can be opened from cell phone 1000 and activated in different ways; we show just one implementation here. In this exemplary implementation, the user has opened the auto-response application from among the various features on the cell phone 1000.

Once the auto response application is opened, a main menu 1010 appears presenting different options for selection by the user. The options shown here are: “Edit Generic Response,” “Custom Answers,” “Timed Answer,” “Settings/LOG,” and “AUTO MODE.” In this example, the feature “Edit Generic Response” is shown highlighted. Highlighting this feature activates the message text window 1020. Below the window 1020 are buttons 1030 so that the user can Accept or Decline the entry shown. This window 1020 shows an exemplary generic message “I'm driving and can't answer right now.” If the user desires to use this generic message, unchanged, for all SENDERS, then all that the user has to do is select Accept and the specified generic message will be configured for transmittal to every SENDER. The process will begin once the user selects “AUTO MODE” to place the phone 1000 in auto-answering mode. The user is also able to edit the generic message and Accept any changes.

FIG. 10B shows the interface when the “Custom Answers” feature is highlighted from the main menu 1010. Here the system presents the user's Contacts available on the phone 1000; however the Contacts that are presented in box 1040 are not necessarily limited to the Contacts listed in the cell phone. For example, if the cell phone 1000 is synced with the user's computer, the system can mine the user's Contacts from Microsoft® Outlook, Twitter, or other communication programs.

FIG. 10C shows the Timer option. Once this feature is selected by the user from the main menu 1010, a timer window 1060 appears. This window 1060 may appear as a window overlay as shown here. In this window 1060 the user is able to select the amount of time (time limit) that the user plans to be unavailable once the AUTO mode is activated. The time limit can be selected by scrolling, add/minus, or by direct input means. Here the timer window 1060 shows add/minus buttons 1062 and a scrolling wheel 1064 for selecting the time limit in hours and minutes.

FIG. 10D shows the Branding embodiment. The Branding embodiment allows user interaction; however, the user is unable to alter the retrieved branding message because the branding message is supplied by a sponsoring entity via a branding server and the sponsored message can change at any time. The user will not necessarily know exactly what branding message is available at the instant the branding message is supplied. In this example, the branding notification window 1080 shown here lets the user know that the auto-response app is currently sponsored (an example is shown) and that a branding message will be embedded in the user's outgoing auto-response messages. The branding message retrieved from the branding server is embedded into the auto-response message selected by the user, either by appending to the end of the configured message, or other means.

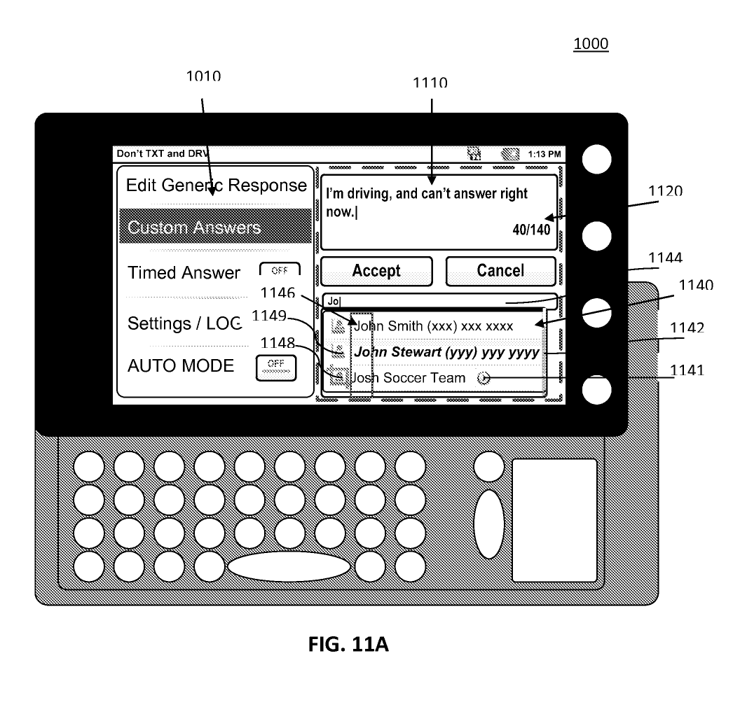

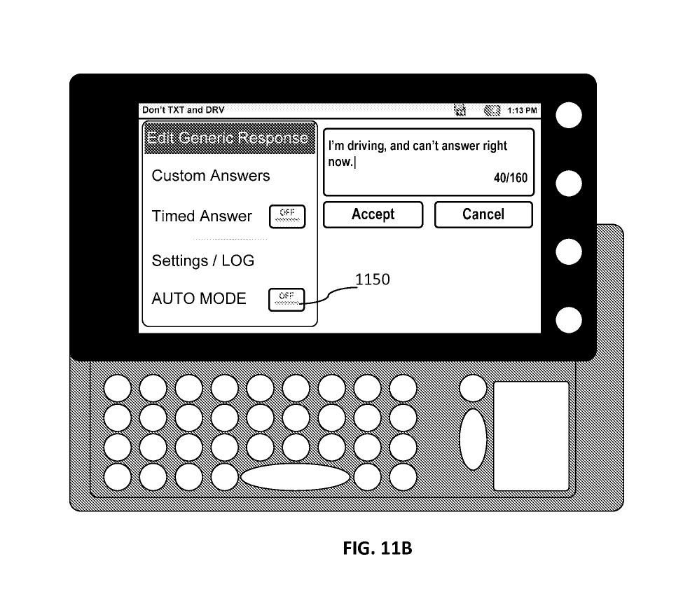

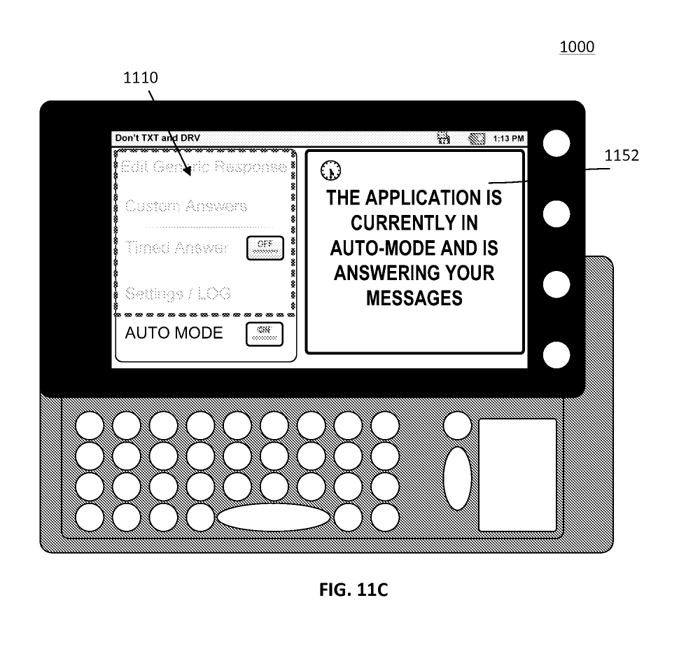

FIG. 11A shows the user interface on the cell phone 1000 when the Custom Answers option is selected. First, the user selects the Custom Answers option from the main menu 1010. Once the user selects this option, a portion of the viewable area of the screen, in this case, the right part of the screen 1110, changes similarly to what is shown in the dashed box of FIG. 11A. Additionally, the user is able to write a custom message in box 1120. Once the message is configured, the user selects the SENDERS (Callers ID) that will receive this message from the list of names in the box 1140. At the beginning the user will see all his phonebook contacts that have no message assigned to them and also any custom groups. Note that a Contact can have only one message associated with his/her Caller ID.

The user can select individual names from the list, for example by clicking on the name. Once selected, the appearance of the name will change so that it can be easily distinguished from the other, non-selected names. In the example of FIG. 11A the font of the selected name is changed to bold and italics; however, other attribute changes can be made within the spirit and scope of the invention, such as font color, background color, blinking, and so on. The contact window 1140 can include a slider 1142. Next, the user can start writing a few letters of the name in the input screen 1144 and the list will be filtered accordingly as demonstrated by section 1146.

In order to denote those Contacts that are part of a group, the application can provide a distinguishing characteristic, such as a symbol or icon 1148 to appear in close proximity to the Contact. Here the icon 1148 is shown to the immediate left of the group Contact to show that it is associated with that Contact. A different icon 1149 can denote that the Contact is not part of a group (an individual Contact). In this example, the Contact associated with icon 1148 is a group Contact, while the Contact associated with icon 1149 is an individual Contact. The type of Contact can be also be denoted by using a different color, a different font, highlighting, or other attribute.

In this example there is shown a button 1141 that will expand the group Contact to show the individual Contacts that are part of the group. Once the user has finished customizing the text and confirms the changes, the user presses the Accept button. Note that the specific buttons and screens are shown for illustrative purposes only and serve to highlight features of the invention; they should not be construed as limiting the invention to the specific features shown.

FIG. 11B shows the user interface for the AUTO Mode. The button “AUTO MODE” places the application in auto-answering mode. In this case the user can put the application in AUTO mode at any time by selecting the “AUTO MODE” button 1150. In FIG. 11B, the AUTO mode is OFF as indicated by the button 1150. Once the button 1150 is pressed it will change the status to AUTO mode ON as indicated in FIG. 11C wherein the button 1150 displays “ON” and shows a green strip. All other on-screen menus in area 1110 will become unavailable (grayed) and a note 1152 will appear on the screen notifying the user that the AUTO mode is ON until the user presses the button 1150 again turning the AUTO Mode OFF. Note that AUTO mode may also be turned ON/OFF by other means such as a toggle switch, scroller wheel or other means.

Timer Option.

The Timer option is particularly useful for drivers who want to inform a SENDER of the amount of time until the driver is able to attend to the message. In addition to the selectable configurations described above, when the user places the phone in auto-answer mode, he/she will be able to input the estimated amount of time he/she will be unavailable (driving, in a meeting, in a task, not willing to answer, etc.). The timer will count down and every message going out may embed the amount of time remaining until the user is available again. The time can be embedded in the message with a special and predefined set of characters in a format such as “$mm” where “mm” equals minutes. The predefined set of characters is given here as an example. For example, assume the user configures the application to respond to any SMS message with the text “I'm currently driving. I'll be able to read ur msg in $mm min. Thanks!!!” Eventually the auto-answer to the text message will be “I'm currently driving. I'll be able to read ur msg in 35 min. Thanks!!!”

Assume the user activates the application and sets the driving time to 90 minutes. After 25 minutes of driving the user receives a text message from SENDER. The auto-response application will return the following message to SENDER: “I'm currently driving. I'll be able to read ur msg in 65 min. Thanks!!!” If the user drives for more than the 90 minutes, the application will return the following message: “I'm currently driving. I'll be able to read ur msg in ??? min. Thanks!!!”

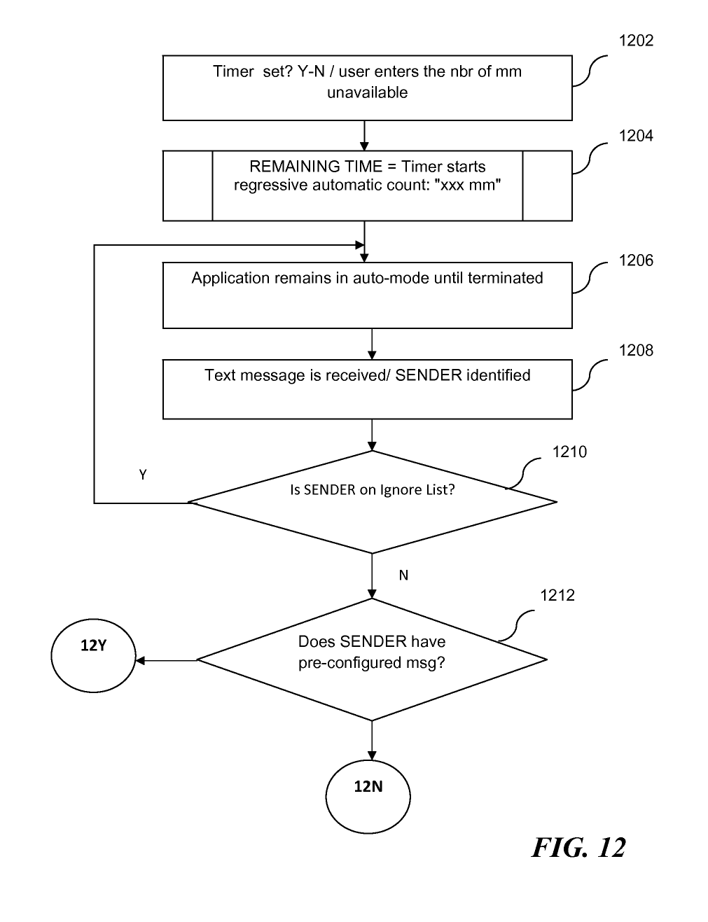

FIG. 12 is a flowchart of the auto-response application when the Timer option is used. In step 1202 the user selects the Timer option and inputs a value representing the amount of time (the time limit) that the user expects to be unavailable. One option is for the user to enter the number of minutes (mm). This automatically triggers the system's counter to count down from the input value of mm at step 1204. Note that this process occurs in the background. In step 1206 we see that the auto-response application remains in AUTO mode until terminated by the user. Next in step 1208 a text message is received and the SENDER of the text message is identified. Step 1210 makes a determination of whether or not the SENDER is on the Ignore list provided by the user. If the SENDER is on the Ignore list, the process loops back to step 1206 to wait for the next message.

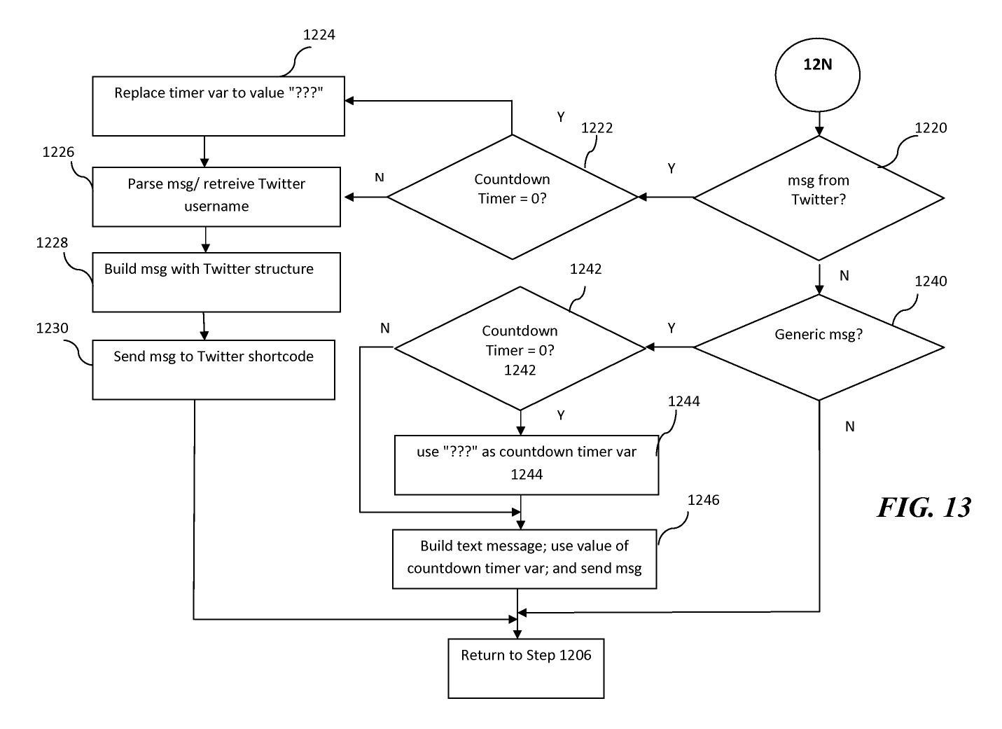

If, on the other hand, the SENDER is not on the Ignore list, then in step 1212 a determination is made as to whether or not the SENDER is flagged as being associated with a custom message. If the SENDER is not associated with a custom message, the process continues as shown in FIG. 13.

Referring to FIG. 13, first, the system checks the message received to determine if it is a Twitter message at step 1220. If the message is a Twitter message, then the countdown timer is queried in step 1222. If the countdown timer is at zero, then in step 1224, the timer variable that will appear in the custom message is replaced with a value such as “???” to denote that the user of the phone is unavailable and it is not known when the user will be available. The process proceeds to the next step.

If the countdown timer is not at zero as determined in step 1222, then the system parses the message and retrieves the Twitter username associated with the SENDER at step 1226. In step 1228 the message is built using the Twitter structure with the value in the countdown timer inserted into the countdown field in the message and in step 1230 the message is sent to the Twitter shortcode. Finally, the process loops back to step 1206.

If step 1220 determines that the message is not a Twitter message, then in step 1240 the system must determine if a generic message has been configured. If no generic message is available (for example, the generic message field is empty), then the process loops back to step 1206. If a generic message is available, the countdown timer is checked. If it is equal to zero in step 1242, a value such as “???” is used for the timer variable in step 1244. If the countdown timer is not zero as determined in step 1242, the message is built with the value in the countdown timer inserted into the countdown field in the message and sent to SENDER in step 1246. The process loops back to step 1206.

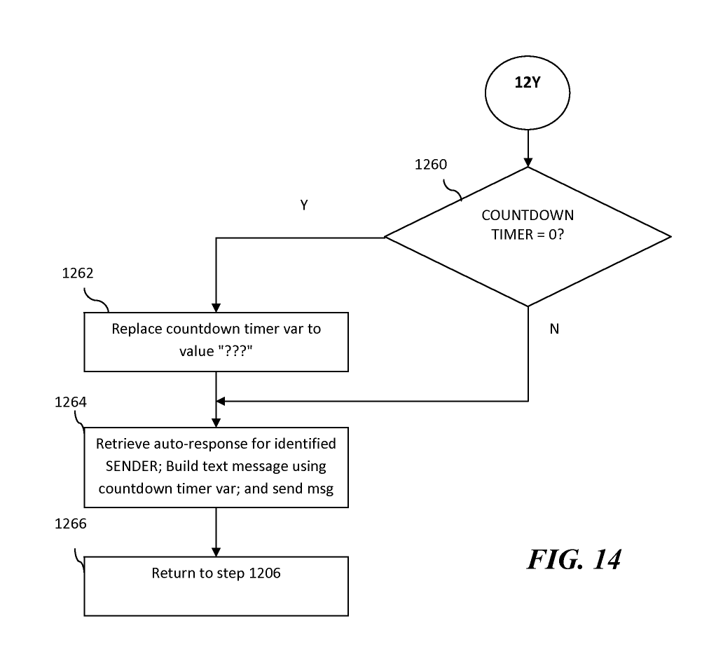

FIG. 14 shows the process when step 1212 of FIG. 12 determines that the SENDER is associated with a custom message. The countdown timer is checked in step 1260. If the countdown timer has reached zero, the countdown timer variable is replaced with a value such as “???” in step 1262. If the countdown timer has not reached zero, then in step 1264 the text message is built with the value currently in the countdown timer field and sent to the SENDER. In step 1266 the process loops back to step 1206.

Generic Option.

The generic message option can be turned ON or OFF. A user is able to set a generic message and that message is stored as a default and is available for the next time the user selects the generic option. In this way, the user does not need to rewrite a generic message every time. In one embodiment of the present invention, the system will have a generic response message pre-loaded.

Ignore Option.

The user is able to designate a list of SENDERS whose calls are to be ignored. This is to avoid answers to specific numbers.

Short-Code Option.

The user is able to disable any auto-response answer to short-codes. That means any number that does not conform as a regular phone number will not receive an answer. The user shall be able to configure and overwrite the above rule with specific short codes. The application will ignore every short-code except the short-codes that the user pre-configures as acceptable. This is particularly useful when the user wants to avoid answering messages from short-codes but wants to still answer other messages such as Twitter messages.

Twitter Option.

SMS messages from Twitter are sent in a specific format with a specific header. The auto-response application will recognize and parse the Twitter header, and issue a direct message to the SENDER.

Group Option.

With the Group option, the user can configure different messages for different groups of SENDERS such that all SENDERS in one group will be associated with one message; while all SENDERS in other group will be associated with a different message, or ignored. The user will be able to define groups of SENDERS as identified by the Caller ID feature available in most cell phones today. In such a way that when defining an answer, instead of configuring for each caller separately, the user will define one answer for the group.

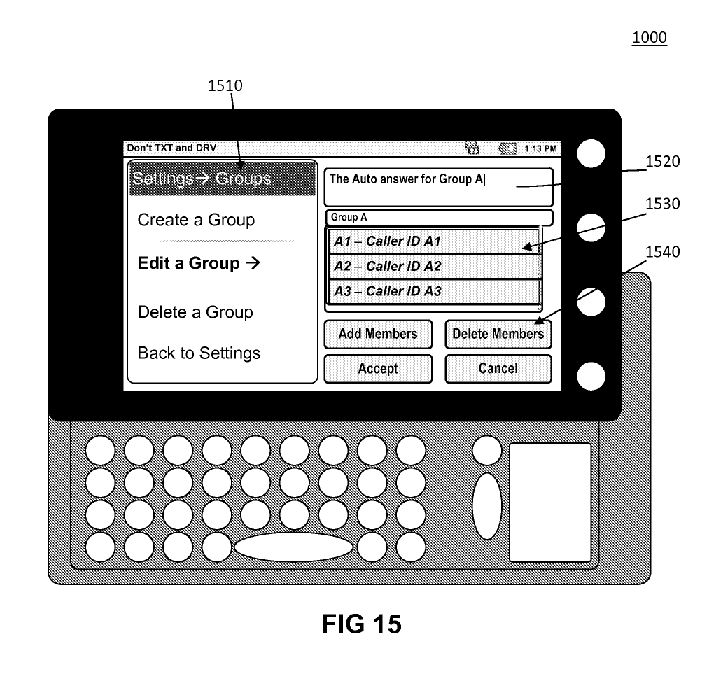

In the example shown in FIG. 15, using the user interface of the cell phone 1000, selecting the Group feature calls up a menu 1510 listing possible actions that a user can take. The examples shown here are: “Create a Group,” “Edit a Group,” “Delete a Group,” and “Back to Settings.” While the “Create,” “Delete,” and “Back” actions are all self-explanatory, we focus on the “Edit a Group” option (shown as selected in FIG. 15). When the “Edit” action is selected, a user is able to change the group settings for a particular group using the action buttons 1540.

While it can be useful to predefine groups, there is no specific need to call or define a group as such. It is enough that the user add additional numbers to the same answer. FIG. 15 provides an example of configuring different messages for Caller ID groups. In FIG. 15 we see the pre-configured auto-response message “The auto answer for Group A” 1520 as configured for SENDERS A1, A2, A3, each of which are associated with a specific Caller ID reference: Caller ID A1, Caller ID A2, Caller ID A3, respectively (shown in the group block 1530). Now when the application recognizes any of the caller IDs the application will automatically send the appropriate message back. i.e., if the application recognizes the caller ID as “Caller ID A2” the application will automatically send “The auto answer for Group A” to A2.

Branding Embodiment.

The Branding embodiment is one way the auto-response application can be monetized. Under certain types of promotions, the auto-response application is provided for free, for example, by downloading for free; or subsidized by certain entities (company, organization, or any other entity). For example, a local government or a mobile provider can decide to provide the application for free to their customers, providing the customers are willing to accept some advertising or promotion (such as a slogan) embedded in their text message responses. The customer might be able to configure the application through any of the above methods; however the application will reserve a certain number of spaces to include a sponsored message. For example, we assume that the application will reserve approximately 35 characters for the sponsored message and therefore the preconfigured message will have a maximum of max=(160−N_{Reserved}).

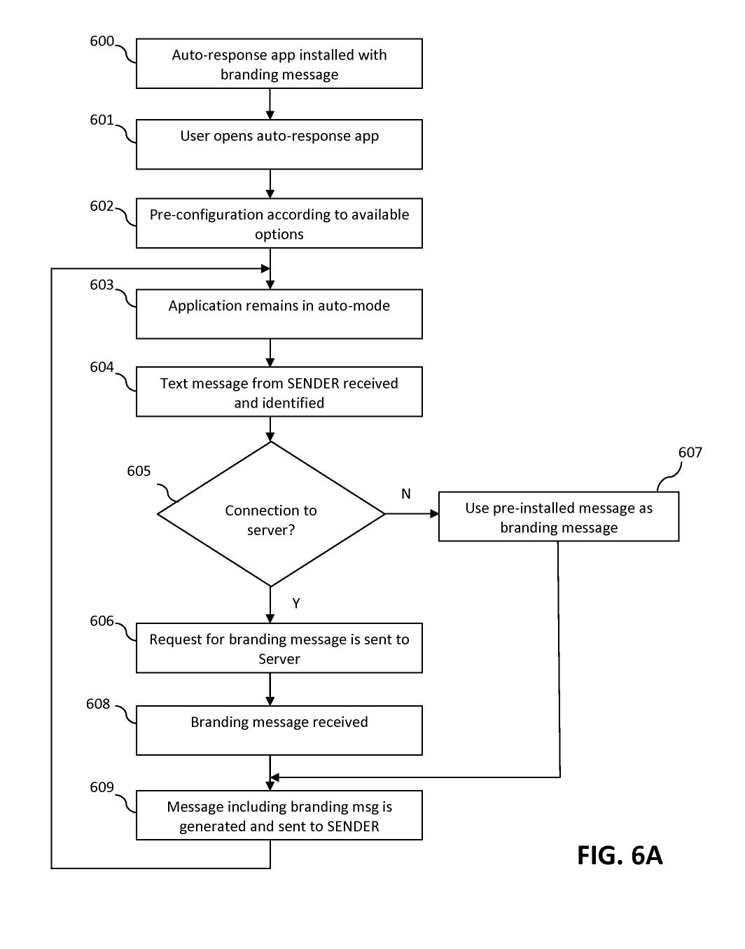

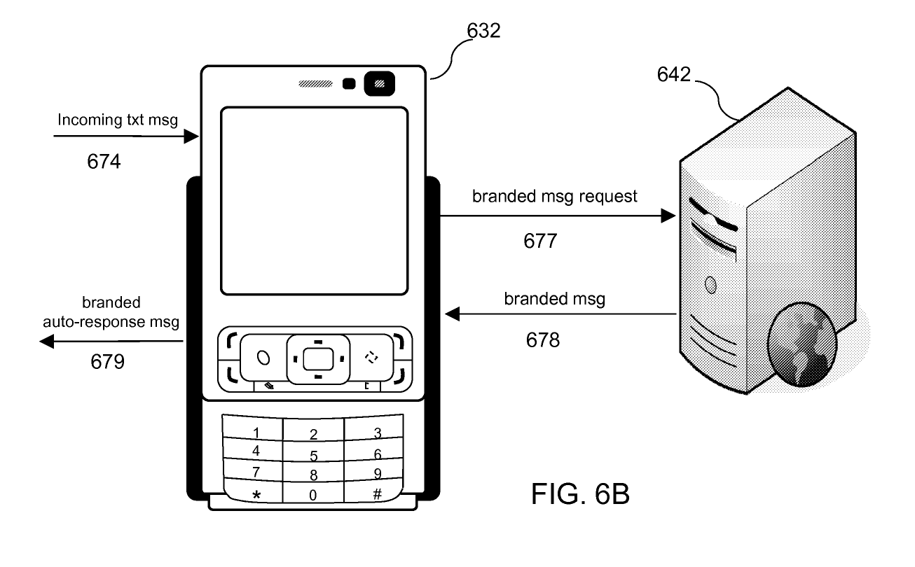

Referring now to FIGS. 6A and 6B, there is shown a simplified flowchart of the Branding embodiment. In step 600 the user installs the auto-response application on his cell phone 632 for the first time. When the application is installed in the Branding embodiment, it includes a pre-configured Branding message. Step 600 is only required for the initial use. In subsequent uses, the process flow will begin at step 601. In step 601 the user opens the auto-response application and then the user configures the system according to the available options in step 602. The user places the auto-response application in AUTO mode in step 603 where it remains until terminated by the user. In step 604, a text message 674 is received and the SENDER is identified.

The following steps occur in the background. Next in step 605, the cell phone 632 attempts to establish a connection with the branding server 642 (this is the server that provides the Branding message). If the cell phone 632 is able to establish a connection with the branding server 642 in step 605, the request 677 for the current Branding message (sponsored message) is sent to the branding server 642 in step 606. Note that a pre-configured Branding message is already included with the application. The reason for requesting a Branding message is to keep current with any new branding messages that may have been changed in the branding server 642 by the sponsoring entity. Note that the “current” Branding message will be the same as the pre-configured message if the Branding message has not changed since the application was installed.

The current Branding message is received 678 from the branding server 642 in step 608. If the sponsoring entity has made a change to the Branding message, the branding server 642 may instruct the application to replace the current default Branding message with the updated Branding message concurrently with delivering the updated Branding message. Once the current Branding message 678 is received, it is appended to the configured response message and the combination message 679 is transmitted to the SENDER in step 609. It is important to note that the Branding message 678 that is received from the branding server 642 may or may not be the same as the default message. The process loops back to step 603. If in step 605 it is determined that the phone 632 cannot establish a connection with the branding server 642, in step 607, the pre-configured branding message is used.

For example, we will assume that the application retrieves the text “Don't txt&drive sponsored by Acme!” as the Branding message 678. Combining the Timer and Branding options can produce a message 679 such as: “I'm currently driving. I'll be able to read ur msg in 35 min. Thanks!!!—Don't txt&drive sponsored by Acme!” The user will not be able to edit the sponsored portion of the message. The content of the sponsored message can vary according to different parameters, such as location, area code prefix, or to answer the sponsoring entity's specific advertising campaign requirements. In cases where a data connection is not available, the application will use the default Branding message. This default Branding message will be the Branding message that was originally installed with the application unless the sponsoring entity has supplied a new Branding message. In that case, the new Branding message becomes the default Branding message.

Implementation.

The functionality of the invention as described herein can be implemented at the handset level, embedded in the phone functionality. It can be added as hardware, software, or a combination. The functionality can also be implemented as part of the cellular phone carrier infrastructure. In this manner, it can be implemented as part of the service provided by the switch network, an SMS server, an SMS gateway, or any other part of the carrier infrastructure.

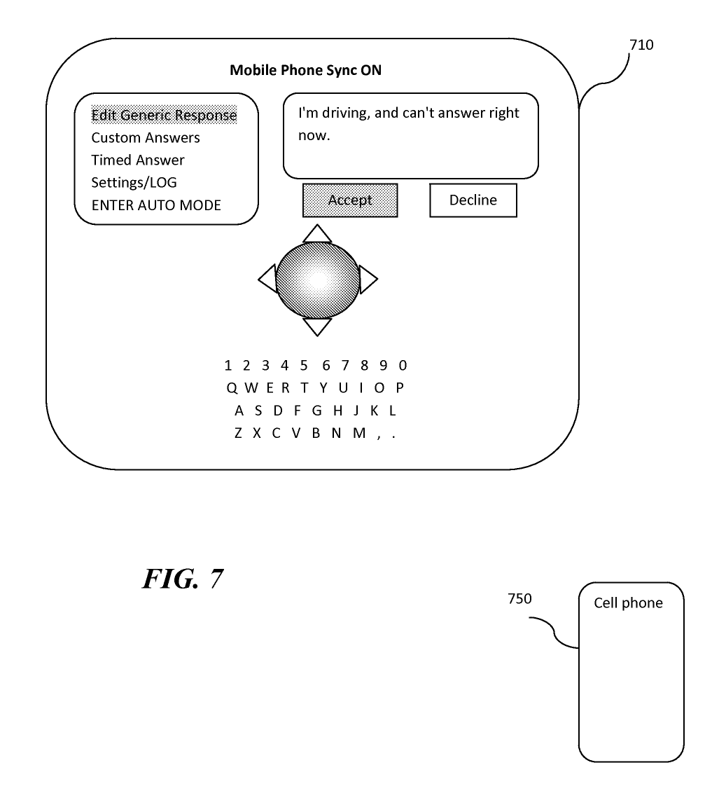

Additionally, the implementation can be done with an external device that communicates with the phone with Bluetooth®, or another communication technology. With the external device implementation, the user is able to configure the auto-response message using another device that is in operative communication with the user's cell phone. FIG. 7 shows the external device implementation in use. We assume that the cell phone 750 is in operative communication (synced) with a car's communication system according to known communication technologies such as Bluetooth®. In this embodiment, the user is able to access the auto-response application from the console 710 of a car and select options and/or input values to use with the auto-response messages. Once the user has activated the auto-response mode, any messages arriving at the user's cell phone 750 will be handled according to the selected configuration. This implementation version allows the user to make immediate use of the functionality when entering a vehicle without having to interact directly with the cell phone. This implementation can be used with any external device provided the external device is in operative communication with the cell phone 750.

System Embodiment.

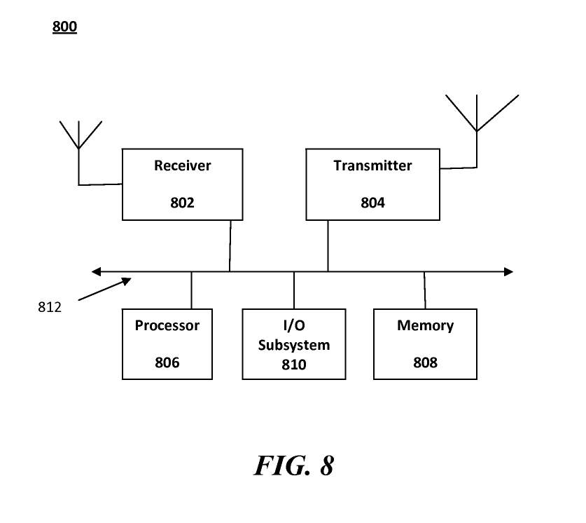

FIG. 8 is a high-level block diagram of a communication device 800 configured to operate according to an embodiment of the present invention. The device 800, which is preferably a cell phone or other device operable to transmit and receive text messages, includes inter alia, a receiver 802, transmitter 804, processor device 806, and memory 808 for storing instructions that are executed by the processor device 806. The communication device 800 further includes an input/output subsystem 810 that includes various user interfaces and the underlying logic for their operation (drivers, etc.), such as a touch screen, keyboard, and others. The various components of the communication device 800 are operatively connected by bus 812. The auto-response app may be embodied in hardware, firmware, and/or software. The auto-response application may be bundled with the communication device 800 or accessible over the Internet using mobile application device software.

Any combination of one or more non-transitory computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable media would include the following: an electrical connection having one or more wires, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, etc.

In the above description, numerous specific details are set forth by way of exemplary embodiments in order to provide a more thorough description of the present invention. It will be apparent, however, to one skilled in the art, that the present invention may be practiced without these specific details. In other instances, well-known features have not been described in detail so as not to obscure the invention. The preferred embodiments of the inventions are described herein in the Detailed Description, Figures and Claims. Unless specifically noted, it is intended that the words and phrases in the specification and claims be given the ordinary and accustomed meaning as understood by those of skill in the applicable art. If any other meaning is intended, the specification will specifically state that a special meaning is being applied to a word or phrase.

Therefore, while there has been described what is presently considered to be the preferred embodiment, it will understood by those skilled in the art that other modifications can be made within the spirit of the invention. The above descriptions of embodiments are not intended to be exhaustive or limiting in scope. The embodiments, as described, were chosen in order to explain the principles of the invention, show its practical application, and enable those with ordinary skill in the art to understand how to make and use the invention. It should be understood that the invention is not limited to the embodiments described above, but rather should be interpreted within the full meaning and scope of the appended claims.

1. A method comprising steps of:
using a user interface of a first communication device for:
receiving input comprising an automatic response message that includes a time limit from a user of the first communication device;
activating an automatic response message feature for automatically generating and transmitting the automatic response message in real-time without user interaction;
using a processor device for:
accessing a clock timer; and
determining remaining time by decrementing the clock timer by a time increment until zero, beginning with the time limit;
using a receiver for receiving a communication from a second communication device, wherein said communication comprises an identification of the second communication device;
using the processor device for:
determining if the automatic response message should be transmitted to the second communication device in response to the communication;
when it is determined that the automatic response message should be transmitted:
embedding a value of the remaining time to the automatic response message to generate a timed response message; and
transmitting the timed response message to the second communication device.

2. The method of claim 1 wherein receiving the input comprises receiving an acceptance of a default response.

3. The method of claim 1 wherein receiving the input comprises receiving the time increment with the time limit.

4. The method of claim 1 wherein the step of embedding the value of the remaining time comprises embedding a non-numeric character value when the remaining time is less than zero.

5. The method of claim 1 wherein receiving the input further comprises receiving a selection of at least one caller identifier designated for receiving the automatic response message.

6. The method of claim 5 wherein receiving the input further comprises receiving a selection of at least one caller identifier designated for not receiving the automatic response message.

7. The method of claim 6 wherein determining if the automatic response message should be transmitted comprises:
accessing storage for caller identifiers designated for receiving the response message; and
comparing the identification of the second communication device with the caller identifiers.

8. The method of claim 1 further comprising:
wherein, when it is determined that the automatic response message should be transmitted:
retrieving a branding message;
appending the branding message to the automatic response message.

9. The method of claim 1 wherein the step of transmitting the timed response message is preceded by a step of inserting a first auto-response identifier comprising an alphanumeric character string in the timed response message to identify said timed response message as an automatically generated message.

10. The method of claim 9 wherein the step of determining if the automatic response message should be transmitted comprises:
retrieving the communication from the second communication device;
checking the communication to determine if it contains an auto-response identifier; and
determining that the automatic response message should not be transmitted to the second communication when said second communication comprises the auto-response identifier.

11. A method comprising steps of:
using a user interface of a first communication device for:
receiving input comprising an automatic response message from a user of the first communication device;
activating an automatic response message feature for automatically preparing and transmitting the automatic response message real-time without user interaction;
using a receiver for receiving a communication from a second communication device, wherein said communication comprises an identification of the second communication device;
using a processor device for:
determining if the automatic response message should be transmitted to the second communication device in response to the communication;
when it is determined that the automatic response message should be transmitted:
retrieving a branding message;
inserting the branding message to the response message to produce a branded response message; and
transmitting the branded response message to the second communication device.

12. The method of claim 11 wherein retrieving the branding message comprises:
establishing a communications link with a remote server; and
retrieving the branding message from the remote server.

13. The method of claim 11 wherein the automatic response feature comprises a pre-installed sponsored message.

14. The method of claim 12 wherein retrieving the branding message comprises:
using the pre-installed sponsored message as the branding message when the communications link cannot be established.

15. The method of claim 12 wherein receiving the input comprises receiving an acceptance of a default response message.

16. The method of claim 12 wherein receiving the input further comprises receiving a selection of at least one caller identifier designated for receiving the automatic response message.

17. The method of claim 16 wherein receiving the input further comprises receiving a selection of at least one caller identifier designated for not receiving the automatic response message.

18. The method of claim 17 wherein determining if the automatic response message should be transmitted comprises:
accessing storage for caller identifiers designated for receiving the response message; and
comparing the identification of the second communication device with the caller identifiers.

19. The method of claim 11 wherein the step of transmitting the branded response message is preceded by a step of inserting a first auto-response identifier comprising an alphanumeric character string in the branded response message to identify said timed response message as an automatically generated message.

20. The method of claim 11 wherein the step of determining if the automatic response message should be transmitted comprises:
retrieving the communication from the second communication device;
checking the communication to determine if it contains an auto-response identifier; and
determining that the automatic response message should not be transmitted to the second communication when said second communication comprises the auto-response identifier.
